(19) United States
(12) Patent Application Publication
(10) Pub. No.: US 2015/0373629 A1
(43) Pub. Date: Dec. 24, 2015

(54) DORMANT CELL DETECTION AND REPORT CONFIGURATION

(71) Applicant: BROADCOM CORPORATION, Irvine, CA (US)

(72) Inventors: Erlin ZENG, Beijing (CN); Wei BAI, Beijing (CN); Pengfei SUN, Beijing (CN); Haiming WANG, Beijing (CN); Jing HAN, Beijing (CN)

(73) Assignee: BROADCOM CORPORATION, Irvine, CA (US)

(21) Appl. No.: 14/765,135

(22) PCT Filed: Feb. 25, 2013
(86) PCT No.: PCT/CN2013/071853

§ 371 Date: Jul. 31, 2015

(51) Int. Cl. H04W 48/16; H04L 12/26; H04W 24/08

(52) U.S. Cl. CPC H04W 48/16; H04W 24/08; H04L 43/08

(57) ABSTRACT

It is provided a method, comprising checking if an indication is received that another cell device will remain in an active state and not enter into a dormant state for a time interval, wherein, in the dormant state, a cell specific reference signal is transmitted less frequently than in the active state; providing a request not to report a detection of an identification signal of the other cell device for the time interval if the indication is received.

### FIELD OF THE INVENTION

The present invention relates to dormant cell detection. In particular, the present invention relates to an apparatus, a method, and a computer program product related to dormant cell detection and related report configuration.

### BACKGROUND OF THE INVENTION

### Abbreviations

### 3GPP 3^{rd} Generation Partnership Project

### LTE™ Long Term Evolution

### LTE-A Long Term Evolution Advanced

### Rel Release

### eNB Enhanced Node B

### NCT New Carrier Type

### RRM Radio Resource Management

### RRC Radio Resource Control

### RS Reference Signal

### UE User Equipment

### Cell ID Cell Identity

ePDCCH evolved PDCCH

### PDCCH Physical Dedicated Control Channel

### DTX Discontinuous Transmission

### CRS Cell-specific Reference Signal

### ID Identity

### MSISDN Mobile Subscriber International ISDN Number

ISDN Integrated services digital network

### IMSI International Mobile Subscriber Identity

### IMEI International Mobile Equipment Identity

In LTE Rel-12, it is intended to define a New Carrier Type (NCT). In new carrier type design, one task is to define corresponding network and UE behaviors to support a new dormant state of eNB for better power efficiency.

According to the agreed work item description [1], Rel-12 NCT will work on dormant/active state of cells, which is not supported by legacy LTE system.

In detail:
Specify necessary means to allow standalone and macro-assisted operation on the New Carrier Type, including
   A broadcast mechanism to acquire system information, a common search space for ePDCCH and UE mobility support.
   If justified by the small cell related studies, specify necessary means to support a dual dormant/active state, which means DTX like eNB behaviour (with long DTX cycles) and corresponding UE procedures, with or without reduced CRS in the active state.

Dormant state may potentially achieve power saving by switching off the legacy signals in the cell, but only transmit the cell identification signal for discovery purpose. Also, it is pointed out in [2] that, in order to support such procedures, one task is to “defining UE RRM procedures for dormant cell proximity detection and report by the UE”. In FIG. 1, one possible design for cell identification signal is that such signal is present regardless of the dormant or active state of the cell [2]. FIG. 1 shows three options:
Option 1: Reduced CRS (Rel-11 NCT), (useful mainly in macro cells)
Option 2: Dormant mode of unloaded cells, (useful in both small cells and macro cells)
Option 3: Dormant mode of unloaded cells+Reduced CRS

Options 2 and 3 show the behavior of a cell in active mode (top) and dormant mode (bottom).

According to option 1, the CRS is transmitted less frequently than according to previous releases.

According to option 2, in active mode, CRS is sent more frequently (substantially all the time when needed according to the load of the cell) than according to Option 1. In addition, cell identification signal is sent from time to time. In the dormant mode, only the cell identification signal is sent.

According to option 3, in active mode, CRS is sent as frequently as according to option 1. In addition, cell identification signal is sent from time to time. In the dormant mode, only the cell identification signal is sent.

Since the behavior of the NCT is not finalized yet, for the time being, it is assumed that, in the dormant mode, the CRS is sent less frequent than in the active mode. This includes a case that CRS is not sent at all in dormant mode.

One possible benefit of such design is UE may use the cell identification signal for measurement as well as comparison of neighboring cells in different states. To always have the cell identification signal present may also simplify the definition of UE requirements for handling frequent and abrupt state transitions by neighbor cells.

### REFERENCES

[1]3GPP RP-121415, New Carrier Type for LTE, Ericsson
[2]3GPP RP-121186, on Rel-12 NCT, Qualcomm

### SUMMARY OF THE INVENTION

It is an object of the present invention to improve the prior art.

In particular, it is an object to design a dormant cell detection procedure and UE reporting configuration which avoids unnecessary reporting overhead.

According to a first aspect of the invention, there is provided an apparatus, comprising at least one processor, at least one memory including computer program code, and the at least one processor, with the at least one memory and the computer program code, being arranged to cause the apparatus to at least perform: estimating a time interval during which the apparatus, from the actual time on, will remain in an active state and not enter into a dormant state, wherein, in the dormant state, a cell specific reference signal is transmitted less frequently than in the active state; providing the time interval to another cell device.

According to a second aspect of the invention, there is provided an apparatus, comprising at least one processor, at least one memory including computer program code, and the at least one processor, with the at least one memory and the computer program code, being arranged to cause the apparatus to at least perform: checking if an Indication is received that another cell device will remain in an active state and not enter into a dormant state for a time interval, wherein, in the dormant state, a cell specific reference signal is transmitted less frequently than in the active state; providing a request not to report a detection of an identification signal of the other cell device for the time interval if the indication is received.

According to a third aspect of the Invention, there is provided an apparatus, comprising at least one processor, at least one memory including computer program code, and the at least one processor, with the at least one memory and the computer program code, being arranged to cause the apparatus to at least perform: providing, dedicated to a user equipment, a request not to report a detection of an identification signal of another cell device.

According to a fourth aspect of the invention, there is provided an apparatus, comprising at least one processor, at least one memory including computer program code, and the at least one processor, with the at least one memory and the computer program code, being arranged to cause the apparatus to at least perform: checking if a request to prohibit reporting of an identification signal of a second cell device is received from a first cell device; prohibiting the reporting of the identification signal if the request is received.

According to a fifth aspect of the invention, there is provided an apparatus, comprising estimating means adapted to estimate a time interval during which the apparatus, from the actual time on, will remain in an active state and not enter into a dormant state, wherein, in the dormant state, a cell specific reference signal is transmitted less frequently than in the active state; providing means adapted to provide the time interval to another cell device.

According to a sixth aspect of the invention, there is provided an apparatus, comprising checking means adapted to check if an indication is received that another cell device will remain in an active state and not enter into a dormant state for a time interval, wherein, in the dormant state, a cell specific reference signal is transmitted less frequently than in the active state; providing means adapted to provide a request not to report a detection of an identification signal of the other cell device for the time interval if the indication is received.

According to a seventh aspect of the invention, there is provided an apparatus, comprising providing means adapted to provide, dedicated to a user equipment, a request not to report a detection of an identification signal of another cell device.

According to an eighth aspect of the invention, there is provided an apparatus, comprising checking means adapted to check if a request to prohibit reporting of an identification signal of a second cell device is received from a first cell device; prohibiting means adapted to prohibit the reporting of the identification signal if the request is received.

According to a ninth aspect of the invention, there is provided a method, comprising estimating a time interval during which an apparatus performing the method, from the actual time on, will remain in an active state and not enter into a dormant state, wherein, in the dormant state, a cell specific reference signal is transmitted less frequently than in the active state; providing the time interval to another cell device.

According to a tenth aspect of the invention, there is provided a method, comprising checking if an indication is received that another cell device will remain in an active state and not enter into a dormant state for a time interval, wherein, in the dormant state, a cell specific reference signal is transmitted less frequently than in the active state; providing a request not to report a detection of an Identification signal of the other cell device for the time interval if the indication is received.

According to an eleventh aspect of the invention, there is provided a method, comprising providing, dedicated to a user equipment, a request not to report a detection of an identification signal of another cell device.

According to a twelfth aspect of the Invention, there is provided a method, comprising checking if a request to prohibit reporting of an identification signal of a second cell device is received from a first cell device; prohibiting the reporting of the identification signal if the request is received.

Each of the methods of the ninth to twelfth aspects may be a method of dormant cell detection.

According to a thirteenth aspect of the invention, there is provided a computer program product comprising a set of instructions which, when executed on an apparatus, is configured to cause the apparatus to carry out the method according to any one of the methods of the ninth to twelfth aspects. The computer program product may be embodied as a computer-readable medium.

According to some embodiments of the invention, for example at least the following advantage is achieved:

Dormant cells may be reliably detected without a large reporting overhead. Reporting efficiency is improved.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows examples of different active/dormant states according to the prior art;

FIG. 2 shows an apparatus according to an embodiment of the invention;

FIG. 3 shows a method according to an embodiment of the invention;

FIG. 4 shows an apparatus according to an embodiment of the invention;

FIG. 5 shows a method according to an embodiment of the invention;

FIG. 6 shows an apparatus according to an embodiment of the invention;

FIG. 7 shows a method according to an embodiment of the invention.

FIG. 8 shows an apparatus according to an embodiment of the invention; and

FIG. 9 shows a method according to an embodiment of the invention.

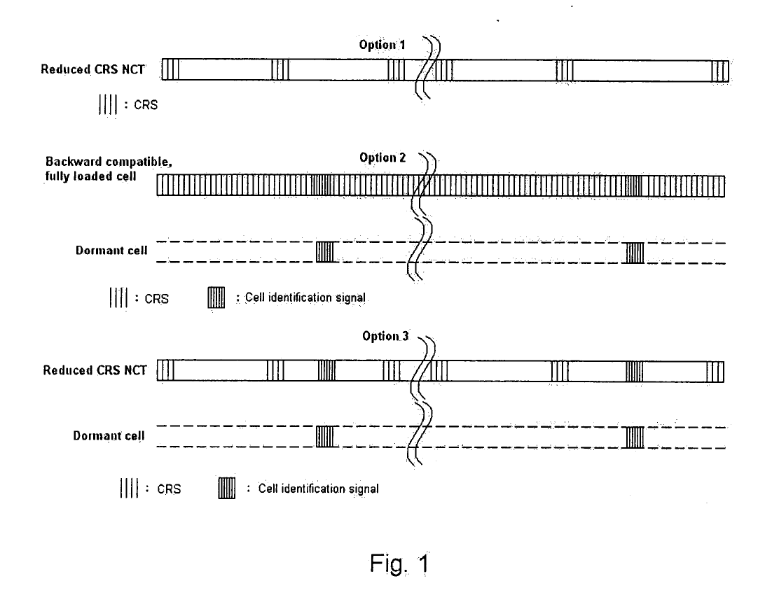

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

Embodiments of the invention improve dormant cell proximity detection and reporting thereon by the UE.

UE shall report to its serving eNB receipt of a cell identification signal of another cell. There is no detailed design available regarding the dormant cell's identification signal detection and reporting configurations. In addition, UE reporting behaviour for the case when both active cells and dormant cells transmit the cell identification signal is not defined.

One option would be to always let UE monitor the cell identification signal and report about it. However, this is unnecessary and Inefficient in terms of reporting overhead.

According to embodiments of the invention, a cell B indicates a time interval (e.g. named T_active) to cell A, during which cell B predicts it will not enter dormant state but remain in active state. E.g., X2 Interface may be used for such information sharing. Then, if the cell identification signal is transmitted on active cell B, cell A prevents its attached UEs from reporting the detection of cell B's identification signal.

In the following, an embodiment of the invention is described at greater detail. It is assumed that UE k is connected to or camping on cell A, and there is at least another neighboring cell B.

There are two cases:

Case 1: Loaded neighboring cell B
In this case, cell B has its own connected or camped UEs, and cell B predicts that in the next time period T_active, it will not enter dormant state.

Case 2: Lightly loaded neighboring cell B
In this case cell B has very few connected or camped UEs (or even no connected or camped UEs), and may enter dormant mode in any time from now on.

In case 1, cell B can make the prediction and share this time interval T_active to cell A via some inter-eNB interface, e.g., X2 interface. According to some embodiments, cell B will then remain in active mode for the time interval T_active. If needed due to a change of the situation in cell B, according to some embodiments, cell B may even update this information during the next time period T_active and, thus, may enter earlier in dormant mode.

According to some embodiments, the shared information may be simplified to a quantized indication of predicted active time from now on. In some embodiments, T_active is predefined, intended to be as a meaningful time period to aid cell A operation. In these embodiments, the shared information is reduced to just two values, i.e., whether or not cell B will possibly enter the dormant mode during the next predefined time period.

In case 2, as it is hard to predict whether or not of cell B will enter from active mode into dormant mode, according to some embodiments no information regarding dormant/active state is provided to cell A. In some embodiments, a smallest T_active value is indicated to cell A.

A low load is only an example of a case where cell B can hardly predict a time during which it will remain in the active state and not enter into the dormant state. In some embodiments, other predefined conditions may be applied instead or in addition: For example, it may be considered if the load history or a load prediction is below a certain threshold, or if a time derivative of any of the load history and the load prediction is below a certain threshold. In some embodiments, a combination of some or all of these predefined conditions may be applied, i.e., cell B can hardly predict the active time only if more than one of the above mentioned predefined conditions are fulfilled.

In case 1, cell A may use higher layer signaling (e.g. broadcast signaling such as system information, or UE specific RRC signaling) to request UE k not to report the detection of the identification signal to cell A. In this way, the unnecessary report of detection is avoided, as cell A knows anyway that cell B is in active state in the time period and, hence, does not need such report to trigger certain wake-up procedure of cell B.

The higher layer signaling can be in different forms, e.g.,
A dormant cell list in the system information of cell A. In this case, UE shall report the detection of the identification signal of cell B if cell B belongs to the list.
An active cell list in the system information of cell A. In this case, UE shall report the detection of the identification signal of cell B if cell B does not belong to the list.

For both examples, the list may have a certain number of cell IDs.

In some embodiments, the list has a certain number of identification signal sequences, which may be used for identification signal in the neighboring cells in dormant state.

In case 2, in some embodiments, cell A may always put cell B in the dormant cell list. Then, even if cell B is in active state, UE k will report the detection of cell B to cell A.

According to some embodiments, the request not to report the detection of cell B may comprise an indication of a time interval (e.g. T_active) during which reports are muted. If no renewal request is received, after the time period, the UE will report the detection. The time period may be predefined such that it needs not to be transmitted in the request.

According to some embodiments, the request not to report the detection of cell B remains valid until an opposite request (i.e. a request to report the detection of cell B) is received.

According to some embodiments aiming to control the report overhead reporting of the detection is UE specific enabled or disabled. For example, even if the identification signal detection configuration is conveyed by system information, network can disable or enable a UE's report via dedicated RRC signaling. If the report is disabled, UE will never report the detection of identification signal of any neighboring cells.

For example, if a large number of UEs camping on or being connected to one (active) cell detect the dormant cell and all of them report the detection to the active cell, this would result in a quite high load on the active cell. So, according to some embodiments of the invention, (active) eNB only allows a subset of UEs to report the detection in order to save overhead. Some example selection criteria for the UEs are as follows: eNB disables report from UEs which are power limited (to avoid them requiring power for reporting), or from UEs at cell edge (because they may create more interference to other cells due to the reporting). According to another example, the selection may be based on UE ID (e.g., UEs with IDs which fulfill UE_ID mod N=0, where N is a positive integer). A UE ID may be e.g. MSISDN, IMSI, or IMEI. Some or all of these selection criteria may be combined.

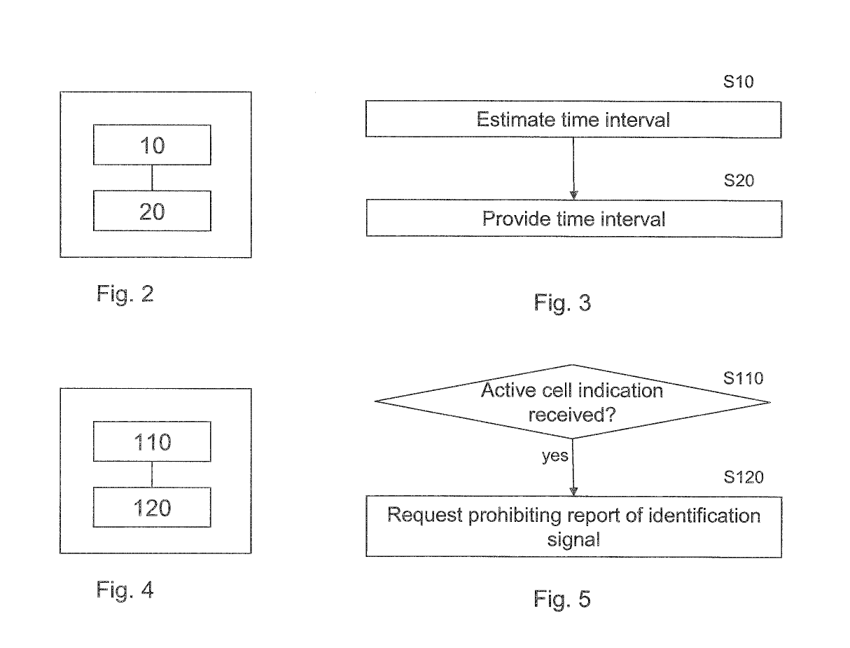

FIG. 2 shows an apparatus according to an embodiment of the invention. The apparatus may be a cell device, a base station device such as an eNB or a part thereof. FIG. 3 shows a method according to an embodiment of the Invention. The apparatus according to FIG. 2 may perform the method of FIG. 3 but is not limited to this method. The method of FIG. 3 may be performed by the apparatus of FIG. 2 but is not limited to being performed by this apparatus.

The apparatus comprises at least one processor 10 and at least one memory 20. The at least one memory 20 includes computer program code, and the at least one processor 10, with the at least one memory 20 and the computer program code is arranged to cause the apparatus to perform estimating (S10) a time interval during which the apparatus will remain in an active state and not enter into a dormant state. The time interval may be a time interval starting from the current time. In the dormant state, a cell specific reference signal is transmitted less frequently than in the active state or even not at all. According to step S20, the time interval is provided to another cell device, e.g. via X.2 interface.

FIG. 4 shows an apparatus according to an embodiment of the invention. The apparatus may be a cell device such as an eNB or a part thereof. FIG. 5 shows a method according to an embodiment of the invention. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises at least one processor 110 and at least one memory 120. The at least one memory 120 includes computer program code, and the at least one processor 110, with the at least one memory 120 and the computer program code is arranged to cause the apparatus to perform checking (S110) if an indication is received that another cell device will remain in the active state and not enter into the dormant state for a time interval. If such an indication is received, a request is provided (S120) not to report for the time interval if an identification signal of the other cell device is detected. The request may be provided based on higher layer signaling (broadcasting or dedicated signaling). It may comprise a time interval for which reporting is to be prohibited.

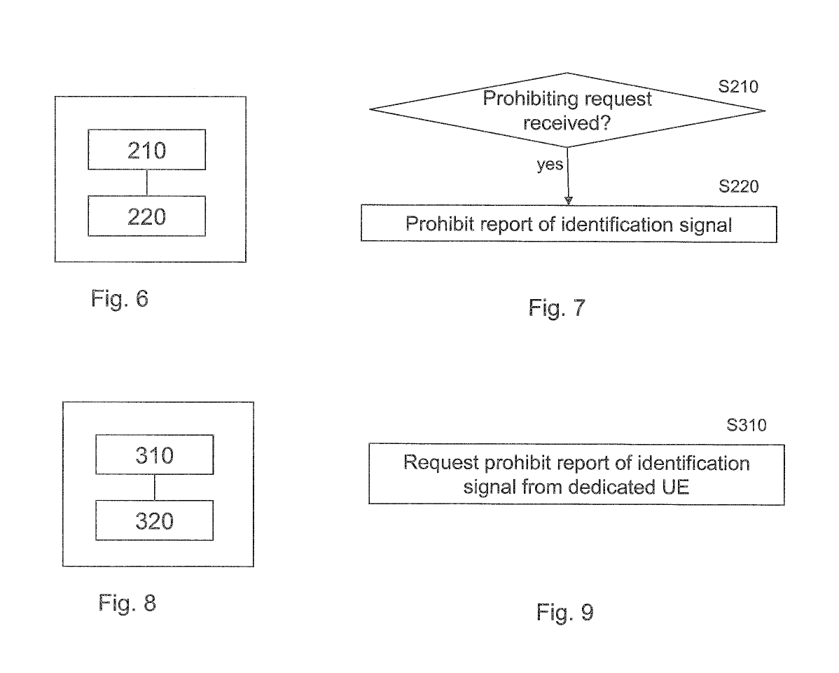

FIG. 6 shows an apparatus according to an embodiment of the invention. The apparatus may be a cell device such as an eNB or a part thereof. FIG. 7 shows a method according to an embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises at least one processor 210 and at least one memory 220. The at least one memory 220 includes computer program code, and the at least one processor 210, with the at least one memory 220 and the computer program code is arranged to cause the apparatus to perform checking (S210) if a request to prohibit reporting of an identification signal of a second cell device is received from a first cell device. If the request is received, the reporting of the identification signal is prohibited (S220).

FIG. 8 shows an apparatus according to an embodiment of the invention. The apparatus may be a cell device such as an eNB or a part thereof. FIG. 9 shows a method according to an embodiment of the invention. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises at least one processor 310 and at least one memory 320. The at least one memory 320 includes computer program code, and the at least one processor 310, with the at least one memory 320 and the computer program code is arranged to cause the apparatus to perform providing (S310) a request not to report an identification signal of another cell device. The request is provided dedicated to a specific UE.

Embodiments of the invention are described based on an LTE-A system but embodiments of the invention may be applied to other radio access technologies such as LTE, WiFi, WLAN, UMTS, HSPA, if a dormant state may be employed.

A terminal may be a machine type device, a user equipment, a mobile phone, a laptop, a smartphone, a tablet PC, or any other device that may attach to a mobile network. A base station may be a NodeB, an eNodeB or any other base station of a radio network.

If not otherwise stated or otherwise made clear from the context, the statement that two entities are different means that they are differently addressed in their respective network. It does not necessarily mean that they are based on different hardware. That is, each of the entities described in the present description may be based on a different hardware, or some or all of the entitles may be based on the same hardware.

According to the above description, it should thus be apparent that exemplary embodiments of the present invention provide, for example a user equipment or a terminal or a component thereof, an apparatus embodying the same, a method for controlling and/or operating the same, and computer program(s) controlling and/or operating the same as well as mediums carrying such computer program(s) and forming computer program product(s).

According to the above description, it should thus be apparent that exemplary embodiments of the present invention provide, for example a base station or a component thereof, an apparatus such as a server embodying the same, a method for controlling and/or operating the same, and computer program(s) controlling and/or operating the same as well as mediums carrying such computer program(s) and forming computer program product(s).

According to exemplarily embodiments of the present invention, a system may comprise any conceivable combination of the thus depicted devices/apparatuses and other network elements, which are configured to cooperate with any one of them.

In general, it is to be noted that respective functional blocks or elements according to above-described aspects can be implemented by any known means, either in hardware and/or software/firmware, respectively, if it is only adapted to perform the described functions of the respective parts. The mentioned method steps can be realized in individual functional blocks or by individual devices, or one or more of the method steps can be realized in a single functional block or by a single device.

Generally, any structural means such as a processor or other circuitry may refer to one or more of the following: (a) hardware-only circuit implementations (such as implementations in only analog and/or digital circuitry) and (b) combinations of circuits and software (and/or firmware), such as (as applicable): (I) a combination of processor(s) or (ii) portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present. Also, it may also cover an implementation of merely a processor (or multiple processors) or portion of a processor and its (or their) accompanying software and/or firmware, any integrated circuit, or the like.

Generally, any procedural step or functionality is suitable to be implemented as software/firmware or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BIMOS (Bipolar MOS), BICMOS (Bipolar CMOS), ECL (Emitter Coupled Logic), TTL (Transistor-Transistor Logic), etc., using for example ASIC (Application Specific IC (Integrated Circuit)) components, FPGA (Feld-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1. An apparatus, comprising
at least one processor,
at least one memory including computer program code, and
the at least one processor, with the at least one memory and the computer program code, being arranged to cause the apparatus to at least perform:
estimating a time interval during which the apparatus, from the actual time on, will remain in an active state and not enter into a dormant state, wherein, in the dormant state, a cell specific reference signal is transmitted less frequently than in the active state;
providing the time interval to another cell device.

2. The apparatus according to claim 1, wherein the at least one processor, with the at least one memory and the computer program code, is further arranged to cause the apparatus to perform the providing via an X2 interface of a third generation partnership network.

3. The apparatus according to claim 1, wherein the estimating is based on at least one of a load, a load history, and a load prediction of the apparatus.

4. The apparatus according to claim 3, wherein the at least one processor, with the at least one memory and the computer program code, is further arranged to cause the apparatus to perform
prohibiting providing the time interval if the at least one of the load, the load history, and the load prediction satisfies a predefined condition.

5. The apparatus according to claim 4, wherein the predefined condition is satisfied if at least one of the at least one of the load, the load history, and the load prediction is below a respective predefined threshold.

6. The apparatus according to claim 1, wherein the cell specific reference signal is not sent in the dormant state.

7. The apparatus according to claim 1, wherein the at least one processor, with the at least one memory and the computer program code, is further arranged to cause the apparatus to perform transmitting a cell identification signal in the dormant state.

8. The apparatus according to claim 1, wherein the apparatus is implemented in a base station of a Long Term Evolution or Long Term Evolution Advanced based cellular communication network.

9-24. (canceled)

25. A method, comprising
estimating a time interval during which an apparatus performing the method, from the actual time on, will remain in an active state and not enter into a dormant state, wherein, in the dormant state, a cell specific reference signal is transmitted less frequently than in the active state;
providing the time interval to another cell device.

26. The method according to claim 25, wherein the providing is performed via an X2 interface of a third generation partnership network.

27. The method according to claim 25, wherein the estimating is based on at least one of a load, a load history, and a load prediction of the apparatus.

28. The method according to claim 27, further comprising
prohibiting providing the time interval if the at least one of the load, the load history, and the load prediction satisfies a predefined condition.

29. The method according to claim 28, wherein the predefined condition is satisfied if at least one of the at least one of the load, the load history, and the load prediction is below a respective predefined threshold.

30. The method according to claim 1, wherein the cell specific reference signal is not sent in the dormant state.

31. The method according to claim 25, further comprising
transmitting a cell identification signal in the dormant state.

32. The method according to claim 1, wherein the method is performed in a base station of a Long Term Evolution or Long Term Evolution Advanced based cellular communication network.

33-48. (canceled)

49. A non-transitory computer program product comprising a set of instructions which, when executed on an apparatus, is configured to cause the apparatus to carry out the method according to claim 25.

50. (canceled)
